(19) United States
(12) Patent Application Publication
(10) Pub. No.: US 2020/0382271 A1
(43) Pub. Date: Dec. 3, 2020

(54) METHODS FOR IMPLEMENTING AND OBFUSCATING A CRYPTOGRAPHIC ALGORITHM HAVING A GIVEN SECRET KEY

(71) Applicant: Idemia Identity & Security France, Courbevoie (FR)

(72) Inventors: Hervé CHABANNE, Courbevoie (FR); Alberto BATTISTELLO, Courbevoie (FR)

(21) Appl. No.: 16/876,216

(22) Filed: May 18, 2020

(30) Foreign Application Priority Data
May 27, 2019 (FR) 1905592

(51) Int. Cl. H04L 9/00

(52) U.S. Cl. CPC H04L 9/002; H04L 2209/08; H04L 2209/16

(57) ABSTRACT

The present invention relates to a method for implementing a cryptographic algorithm having a given secret key comprising the execution by data processing means (11a) of an equipment (10a) of a code implementing said cryptographic algorithm stored on data storage means (12a) of the equipment (10a), the method being characterized in that at least one so-called obfuscated part of said code parameterized with said secret key uses only one so-called cmov instruction, which is a conditional move instruction in a first operand of the instruction of a second operand of the instruction, with at least one occurrence of said cmov instruction in said obfuscated part of the code being dummy.

### CROSS-REFERENCE TO RELATED APPLICATIONS

This specification is based upon and claims the benefit of priority from French patent application number FR 1905592 filed on May 27, 2019, the entire contents of which are incorporated herein by reference.

### GENERAL TECHNICAL FIELD

The present invention relates to the field of cryptography, and in particular to an encryption/decryption method of the “white box” type.

### STATE OF THE ART

A function is considered a “black box” when it is not possible to access its internal operation, i.e. it is possible to know its inputs and outputs but not its secret parameters or its intermediate states.

Cryptographic algorithms (e.g. for encryption or signature) are thus conventionally assumed to be black boxes when their reliability (resistance to attacks) is evaluated.

For example, if one takes the typical cryptographic algorithms such as DES (“Data Encryption Standard”), 3DES (Triple DES) or AES (“Advanced Encryption Standard”), these work on blocks of 64 or 128 bit size (and in the future 256 bit) but cannot process such a block in a single operation (there are already more than 10¹⁹ possible values of 64 bit blocks). It is thus necessary to work within a block on smaller elements, typically of 8-bit size (only 256 possibilities) by concatenating non-linear operations with linear operations.

The black box hypothesis assumes in this case that the keys or intermediate states are inaccessible. This hypothesis imposes a strong constraint on the storage and manipulation of these parameters. Indeed, tools have been recently published to allow the automation of attacks on hardware implementation, called auxiliary channel or fault attacks.

Today, for many cases of use including mobile payment, it is necessary to deploy cryptographic algorithms making the least possible assumptions about the security of the target hardware. Secure storage and manipulation of secret parameters must then be assured at the application level.

The so-called white box cryptography aims at meeting this challenge by proposing implementations of the cryptographic algorithms, which are supposed to make the extraction of secrets impossible, even in the case of an attack allowing the attacker full access to the software implementation of the algorithm. More precisely, a function is considered as a “white box” when its mechanisms are visible. In other words, it is directly assumed that the attacker has access to whatever he/she wants (the binary is completely visible and modifiable by the attacker and the latter has full control of the execution platform). As a result, the implementation itself is the only line of defense.

The strength of the products developed is based on a mixture of mathematical principles and software obfuscation. For example, it has been proposed to “mask” the internal states by random (unknown but constant) permutations called internal encodings. However, nowadays the strength of protections based solely on mathematical principles does not seem sufficient, cf. Brecht Wyseur Software Security: White-Box Cryptography. PhD Thesis 2009.

Additionally, it has been shown in the articles Joppe W. Bos, Charles Hubain, Wil Michiels, Philippe Teuwen: Differential Computation Analysis: Hiding Your White-Box Designs is Not Enough, CHES2016, Sanfelix, Eloi, Cristofaro Mune, and Job de Haas. “Unboxing the white-box.” Black Hat EU 2015. 2015, and Jacob, M., Boneh, D., & Felten, E. (2002, November). Attacking an obfuscated cipher by injecting faults. In ACM Workshop on Digital Rights Management (pp. 16-31). Springer, Berlin, Heidelberg, that so-called auxiliary channel or fault attacks can be successfully transposed into white box cryptography.

It would therefore be desirable to have a new “white box” cryptography solution using standard mechanisms such as DES and AES that is completely resistant to all known attacks (by channel analysis, fault, etc.).

### BRIEF DESCRIPTION OF THE INVENTION

According to a first aspect, the present invention relates to a method for implementing a cryptographic algorithm with a given secret key comprising the execution, by data processing means of an equipment, of a code implementing said cryptographic algorithm stored on data storage means of the equipment, the method being characterized in that at least one so-called obfuscated part of said code parameterized with said secret key uses only one so-called cmov instruction, which is a conditional move instruction in a first operand of the instruction of a second operand of the instruction, with at least one occurrence of said cmov instruction in said obfuscated part of the code being dummy.

According to advantageous and non-limiting characteristics:

said conditional move instruction cmov in a first operand of the instruction of a second operand of the instruction implements:
either, if a condition is verified, the actual move in the first operand of the second operand;
or, if said condition is not verified, a simulation move in the first operand of the second operand;
said dummy occurrence of the cmov instruction being intended to implement said move simulation in the first operand of the second operand during the normal execution of said code;
said move simulation in the first operand of the second operand comprises either the actual move in the first operand of the first operand or the actual move of the second operand elsewhere than in the first operand;

each conditional move instruction cmov in a first operand of the instruction of a second operand of the instruction is expressed from an encapsulated so-called unconditional move instruction mov in the first operand of the second operand; the data processing means implement a secure execution environment, wherein said code implementing said cryptographic algorithm is executed, such as the Secure Guard Extension environment;
said obfuscated code part comprises a plurality of dummy occurrences of cmov instructions for each real occurrence of a cmov instruction;
for a set of a real occurrence and the corresponding M−1 dummy occurrences of cmov instructions, corresponding to all the M possible values oᵢ of an object denoted o, including an expected value r, it results that:
for the i-th occurrence of the set, the move condition is “o is equal to oᵢ”;
the real occurrence is the j-th such that oⱼ=r,
all other occurrences of the set are dummy occurrences;
   said code is in a language for assembling the data processing means;
   said assembly language is the x86 assembler;
   said cryptographic algorithm is a symmetrical encryption algorithm, said obfuscated part of the code implementing at least one round of said symmetrical encryption algorithm.

According to a second aspect, the invention relates to a method for obfuscating a cryptographic algorithm with a given secret key represented by a first computer code comprising the implementation by data processing means of a server with the steps:

(a) rewriting the first code into a second code wherein at least one so-called obfuscated part of said code using said secret key uses only one so-called mov instruction, which is an instruction for an unconditional move in a first operand of the instruction of a second operand of the instruction;
(b) generating a third code corresponding to the second code wherein each mov instruction of the obfuscated part is replaced by a so-called cmov instruction, which is an instruction for a conditional move in a first operand of the instruction of a second operand of the instruction, at least one dummy cmov instruction being added.

According to advantageous but non-limiting characteristics, the method comprises a step (c) of transmitting the third code to the equipment for storage on storage means of an equipment with a view to the execution by data processing means of the equipment in order to implement said cryptographic algorithm.

According to a third and fourth aspect, the invention relates to a computer program product comprising code instructions for the execution of a method according to the first aspect or according to the second aspect for implementing or obfuscating a cryptographic algorithm with a given secret key, and a storage means readable by a computer equipment on which a computer program product comprises code instructions for executing a method according to the first aspect or according to the second aspect of implementing an obfuscation of a cryptographic algorithm with a given secret key.

### DESCRIPTION OF THE FIGURES

Other characteristics and advantages of the present invention will appear upon reading the following description of a preferred embodiment. This description will be given with reference to the attached drawings in which:

FIG. 1 is a diagram of an architecture for the implementation of the methods according to the invention;

FIG. 2 illustrates an embodiment of a method for obfuscating according to the invention.

### DETAILED DESCRIPTION

### Architecture

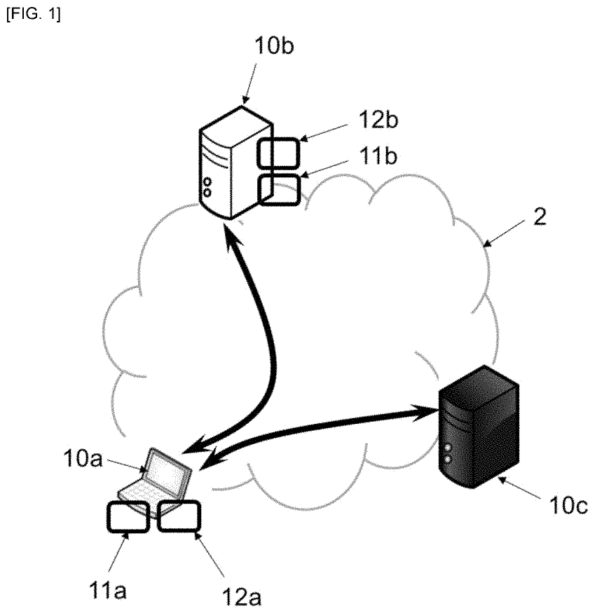

Referring to FIG. 1 a method for implementing a “white box” cryptographic algorithm implemented within an equipment 10a such as a mobile terminal (smartphone, touch pad, etc.), i.e. a piece of equipment not having a particularly secure hardware and which may be the subject of attacks on hardware implementation, and for which the white box approach is of the greatest interest; as well as a method for obfuscating the cryptographic algorithm allowing this white box implementation, are proposed.

The equipment 10a comprises data processing means 11a (a processor) and data storage means 12a (a memory, e.g. a flash memory).

The equipment 10a is, for example, connected to a server 10b, for example, via the Internet network 20. It may require receiving from this server 10b (e.g., that of a provider of security solutions) pieces of code (which will be described below) containing secrets which will be stored in the memory 12a and used for the implementation of the present method.

The equipment 10a may itself be connected to other third-party servers 10c with which it can exchange encrypted data by means of the present method.

### Cryptographic Method

The method according to the first aspect is a method for implementing a cryptographic algorithm, in particular an “encryption or decryption” method, which means that it makes possible, depending on the case, to encrypt data or to decrypt them. It is thus in particular of the symmetrical type, or of the “secret key” type, or of the asymmetrical type (e.g., a signature algorithm, for which third parties have a public key).

It will be understood that the present method is a new implementation of known algorithms, such as 3DES or AES, which are the current standards. More precisely, it does not propose a new encryption strategy, but only a new implementation of the algorithm, and thus a new way of manipulating the data within the algorithm that is resistant to all “white box” attacks. Thus, the present method conventionally comprises the execution by the data processing means 11a of the equipment 10a of a code implementing in an obfuscated manner (for at least part of the code referred to as the obfuscated part) said cryptographic function stored on the data storage means 12a. Said code is preferably in a language directly interpretable by the data means 11a referred to as assembly language. For example, processors of the x86 family (which constitute the vast majority of processors currently in service) recognize an x86 assembly language using an x86 set of instructions. In the remainder of the present disclosure, the example of x86 will be taken.

“Obfuscation” means herein the fact of making the computer code “illegible or incomprehensible” in order to generally prevent reverse engineering and in particular to prevent access to the algorithm and its keys.

It should be noted that the code of the entire algorithm does not necessarily need to be completely obfuscated in the manner which will be disclosed, it is sufficient in practice for the so-called “sensitive” parts to be obfuscated, in particular those representative of the operations parameterized with said secret key, and most particularly those comprising the application of substitution functions.

More precisely, according to a conventional scheme, the algorithm implemented processes the data block by block, and within a block it manipulates elements of a smaller size, for example 16 elements of a byte for a 128 bit block (e.g., in the case of AES). These elements are typically manipulated in pairs.

Thus, the present method preferably encrypts or decrypts an n-tuple of data {aᵢ}_{i<n} with an n-tuple of predetermined secret keys {kᵢ}_{i<n}.

Each element aᵢ of said data n-tuple {aᵢ}_{i<n} has a value in a space {0;1}^{k} denoted [symbol] ₂^{k} and advantageously has a size of one byte (an 8-bit “byte”, i.e. k=8).

To process a complete block from smaller elements, it is necessary to multiply the operations within the block, and for this purpose the present method advantageously comprises, in a conventional manner, the use of a substitution non-linear function f, combined with the use of a linear multiplexing function L, each given based on the cryptographic algorithm to be implemented.

The substitution function f is a function parameterized with a secret key k which takes an input element of [symbol] ₂^{k} as input and generates an output element of the same size (i.e. of [symbol] ₂^{k}). These functions are well known, and for example in the case of DES and AES, the function f is often tabulated and then called an S-box.

The algorithm typically comprises the alternation of a step of using f for permuting elements and then a step of using L for transmitting the data, and so on until the entire block has been processed, this is what is called a round of the algorithm. It will thus be understood that the present method advantageously comprises the repetition of this so as to encrypt or decrypt a set of data comprising those of said n-tuple {aᵢ}_{i<n}.

The sensitive parts, which will be obfuscated as disclosed below, may be limited, in particular, to the first and/or last rounds (e.g., the first/last three in AES), in other words, the applications in the first and/or the last rounds of the substitution functions using said secret key.

It should be noted that there are attacks that only target the middle rounds; it is, therefore, possible to obfuscate the parts corresponding to all the rounds if a complete protection is sought.

It should also be noted that, protecting only the substitution function is not always sufficient; it may be interesting to protect the sensitive data through all the operations until it depends on too many key bits for an attack to be possible. For example, for AES, this corresponds to going as far as the “mix columns” of the second round.

### Principle of the Invention

The present method is noteworthy in that the at least one so-called obfuscated part of said code uses only one so-called cmov instruction, which is an instruction for a conditional move in a first operand of the instruction of a second operand of the instruction, with at least one occurrence of said cmov instruction in said obfuscated part of the code being dummy.

More precisely, said obfuscated part consists of a plurality of instructions, each being a cmov instruction, i.e. there are no instructions other than cmov instructions.

Naturally, two cmov instructions of said part will not be identical; they may have different operands (i.e. arguments, parameters). It should be noted that each operand may be a register, a memory address, a literal value or a label, and in a typical case, these are two registers so that the move consists in writing the contents of the register designated by the second operand into the register designated by the first operand.

The conditional move instruction cmov is understood by comparison to a conventional instruction (in particular of the x86 set of instructions) referred to as unconditional move mov in the first operand of the second operand of the instruction, i.e., only move.

Indeed, cmov implements the move if and only if a condition is verified, whereas mov always implements it. Typically, this condition is the value of a boolean variable called “flag”.

Advantageously, the cmov instruction implements more precisely:
either, if the condition is verified, the actual move in the first operand of the second operand (i.e., the normal mov instruction);
or, if the condition is not verified, a simulation of a move in the first operand of the second operand.

The idea is that an attacker with access to the equipment cannot distinguish between the two branches of the instruction, i.e., cannot tell whether the move was actually made or not.

The simulation thus advantageously comprises, as a true move, a memory access and a write memory, but naturally, the simulation does not comprise the actual move in the first operand of the second operand.

In particular, the destination (the first operand) will be accessed but its current content will be copied there instead of the second operand. Thus, in a certain way, the simulation of a move in the first operand of the second operand can be seen as a move in the first operand of the first operand (which leaves the memory as it stands).

Alternatively, the simulation may comprise the move to another destination which will not be used, i.e. see the simulation of a move in the first operand of the second operand as a move of the second operand elsewhere than in the first operand.

It should be noted that the cmov instruction can either exist natively in the set of instructions recognized by the data processing means (it should be noted that this is not the case in the original x86 set of instructions, but more recent versions include it. It should be noted that the original set of instructions comprises a cmovz instruction for “conditional move if zero” which is conditional but does not have the parameter condition: more precisely, the move is effected if a zero indicator (Zero Flag, ZF) has the value 1), or is obtained by means of a “wrapper” using the basic instructions. More precisely, a basic mov instruction is encapsulated in the wrapper.

In particular, it is possible to use, e.g., the wrapper in original x86 instructions following (using the cmovz instruction), proposed in the document Ashay Rane, Calvin Lin, Mohit Tiwari: Raccoon: Closing Digital Side-Channels through Obfuscated Execution. USENIX Security Symposium 2015:

| | |
|---|---|
| 01: | cmov(uint8_t pred,uint32_t t_val,uint32_t f_val){ |

| | |
|---|---|
| 02: | uint32_t result; |
| 03: | _{——}asm_{——} volatile ( |

| | | |
|---|---|---|
| 04: | “mov | %2, %0;” |
| 05: | “test | %1, %1;” |
| 06: | “cmovz | %3, %0;” |
| 07: | “test | %2, %2;” |

| | |
|---|---|
| 08: | : “=r” (result) |
| 09: | : “r” (pred),“r” (t_val),“r” (f_val) |
| 10: | : “cc” |

| | |
|---|---|
| 11: | ); |
| 12: | return result; |

| | |
|---|---|
| 13: | } |

The small size of the code of this wrapper allows each instruction to be thoroughly inspected for detecting any eventual information leaks. As the code acts only on the processor registers and never accesses the memory, it can operate within the limits of a secure zone of the processor. The secret condition is loaded into the register %1. The mov instruction of line 4 initializes the destination register with t_val. The test instruction in line 5 checks whether pred is equal to zero and updates a zero indicator (Zero Flag, ZF), a sign indicator (Sign Flag, SF) and a parity indicator (Parity Flag, PF) to reflect the comparison. The following cmovz instruction copies the value f_val in the destination register only if pred is equal to zero. At this stage, ZF, SF and PF still contain the results of the comparison. The test instruction on line 7 overwrites these indicators by comparing known non-secret values.

The use of the cmov instruction was disclosed in document Adil Ahmad, Byunggill Joe, Yuan Xiao, Yinqian Zhang, Insik Shin, and Byoungyoung Lee, OBFSCURO: A Commodity Obfuscation Engine on Intel SGX, NDSS 2019, to which a skilled person may refer (see also Adil Ahmad, Kyungtae Kim, Muhammad Ihsanulhaq Sarfaraz, Byoungyoung Lee: OBLIVIATE: A Data Oblivious Filesystem for Intel SGX. NDSS 2018) as a solution to flaws in the SGX (Secure Guard Extensions) environment.

More precisely, SGX proposes to allocate private memory regions (referred to as secure enclaves), the content of which is protected and inaccessible for reading or writing purposes, including by processes executed at higher privilege levels, i.e. to have a space where programs can be protectively executed in confidentiality and integrity, in particular, protected from the OS, with a view to implementing sensitive algorithms therein in complete security. The enclave can be seen as an “inverted sandbox”, allowing a more robust black box implementation. In other words, it is understood that SGX does not offer any white-box protection by itself: the programs that are executed in the enclave are generally written in ordinary manner, with accessible internal keys and states, the protection being provided by the leakproofness of the enclave.

Moreover, this architecture has proved susceptible to being attacked in many ways, for example by attacks through auxiliary channels (leaks, cache attacks, on the patterns of access to the data) or by Spectrum type attacks.

OBLIVIATE/OBFSCURO solutions seek to correct some of these vulnerabilities by adding “obliviousness”, i.e. the fact of not leaving traces (e.g. the cache) that could be detected by auxiliary channel attacks. For this, the use of Oblivious RAM type algorithms (E. Stefanov, M. Van Dijk, E. Shi, C. Fletcher, L. Ren, X Yu, and S. Devadas, “Path oram: an extremely simple oblivious ram protocol,” in Proceedings of the 20th ACM Conference on Computer and Communications Security (CCS), Berlin, Germany, Oct. 2013) to hide accesses to a resource, combined with cmov instructions, is proposed. OBFSCURO thus succeeds in preventing certain attacks through auxiliary channels, in this case those through timing or through cache.

However, it is found that many other attacks through auxiliary channels remain possible, in particular attacks through consumption, electromagnetic emanations, faults, and in general, possible attacks when full access to the hardware is available.

In other words, if OBFSCURO is effective in the case of cryptographic algorithms implemented on a remote equipment such as a server, this is not the case for an equipment 10a of the mobile terminal type.

The idea behind the present method is that any computer code can be written ONLY using the cmov instruction, and thereby solve the limitations of OBFSCURO.

Indeed, it has been demonstrated that the mov (unconditional) instruction is Turing-complete, and therefore that any code can be rewritten entirely from the mov instruction.

There is in particular the M/o/Vfuscator compiler, which takes x86 code as input and rewrites it using only the mov instruction. Naturally, the code obtained is unnecessarily long and complex and, therefore, obfuscated. It should be noted that, on average, the size of the code file is multiplied by 35 due to the rewriting.

From there, the same code written this time with cmov instructions instead of mov becomes unassailable, even in the case of accessible hardware and therefore in a white box environment, since each instruction of the code is untraceable due to the fact of its conditional nature.

Naturally, at least one occurrence of said cmov instruction in said obfuscated part of the code must be dummy. “Dummy” means that the condition is not true during the normal execution of said code, and therefore that the move defined by this instruction is not intended to be implemented. There is also the term decoy instruction in the sense that it is only there to deceive an attacker and not to contribute to the algorithm. In other words, if the move indicated by this instruction were really carried out, the execution would result in an error.

More precisely, let's assume that the code can be written with N mov instructions; if only N cmov instructions are used it is because the condition is true all the time and none simulates a move. If N′>N cmov instructions are used, then even knowing that there are only N instructions that are really to be implemented, an attacker would not know which ones they are and would not distinguish them from the N′−N>0 dummy instructions.

In the preferred embodiment, where each cmov instruction triggers a real move or a simulation, the dummy instruction is intended to implement a move simulation in the first operand of the second operand.

In summary, when executing the obfuscated part, each cmov instruction will be executed, whether it is real or dummy, but only the execution of the real cmovs will give rise to an effective and correct move (the execution of the dummy cmovs gives rise to either a false move or an incorrect move).

According to a first embodiment, it is possible to execute the obfuscated code in a secure execution environment such as SGX by using, e.g., for each cmov the wrapper as defined above.

If an entirely white box environment is desired (i.e. run in a conventional and insecure manner on any processor), according to a second embodiment a wrapper inspired by that which is disclosed in the document Emmanuel Prouff, Matthieu Rivain: A Generic Method for Secure SBox Implementation. WISA 2007 could be used.

This document proposes an implementation of an S-Box wherein all the possible values from 0 to 2^{k}−1 (assuming the S-Box with values in [symbol] ₂^{k}) of an object are considered all false except one. This principle can be extended to cmov instructions: each mov instruction is duplicated into a plurality of cmov instructions, one of which is “true”, and the remainder are dummy. In other words, assuming that the code can be written with N mov instructions and that there are M possible values of an object, N×M cmov instructions are used, including N real instructions and N×(M−1) dummy instructions.

More precisely, for an “associated” set of instructions cmov_{i,i<M} (cmovᵢ designating the i-th cmov instruction of the set) including one real instruction and M−1 dummy instructions, corresponding to all the M oᵢ possible values of an object denoted o, including an expected value r, it results that:
for each cmovᵢ, the condition is “o is equal to oᵢ”;
the real instruction is cmovⱼ such that ⱼ=r,
all the other cmov (i.e. oᵢ≠r) are dummy instructions.

As such, the skilled person may use as wrapper one of the algorithms of this document Emmanuel Prouff, Matthieu Rivain: A Generic Method for Secure SBox Implementation. WISA 2007.

Alternatively or in addition, to be sure of being able to counter an adversary wanting to cheat the execution, duplication techniques can be used by implementing threads for parallel execution of the different alternative cmov instructions (real or dummy, in particular for simultaneous execution of the M cmov instructions corresponding to the M different values of an object), see the document Oscar Reparaz, Lauren De Meyer, Begül Bilgin, Victor Arribas, Svetla Nikova, Ventzislav Nikov, Nigel P. Smart: CAPA: The Spirit of Beaver Against Physical Attacks. CRYPTO (1) 2018.

By combining all these obfuscation techniques, and taking M=2⁸=256, it is noted that the size of the original code implementing the cryptographic algorithm is typically multiplied by at least 10000. Knowing that each of the instructions can be both real and dummy, it is understood that it is no longer possible, by any attack through any auxiliary channel, to identify usable information.

### Obfuscation Method

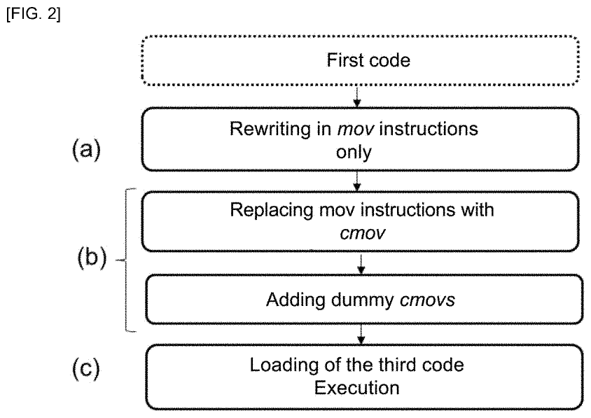

According to a second aspect, and referring back to FIG. 2, a method for obfuscating a cryptographic algorithm with a given secret key represented by a first computer code, i.e. a method for obtaining said obfuscated code (which will be designated as a third code) for the implementation of the algorithm, in accordance with the first aspect is proposed. The first code is typically the assembly language code as written directly or compiled from a conventional programming language, i.e. non-obfuscated and using various instructions.

This method is typically implemented in a secure manner on the server 10b.

Thus, the data processing means 11b of the server 10b begin with a step (a) of rewriting the first code into a second code wherein at least a so-called obfuscated part of said code using said secret key uses only a single so-called mov instruction, which is an instruction for unconditional move in a first operand of the instruction of a second operand of the instruction.

In other words, the original code is transformed into mov-only by using a tool such as M/o/Vfuscator.

It should be noted that the second code could be directly compiled from a first code, which would not be in an assembly language.

In a following step (b), a third code corresponding to the second code is generated wherein each mov instruction of the obfuscated part is replaced by a so-called cmov instruction, which is an instruction for conditional move in a first operand of the instruction of a second operand of the instruction. At this stage, each cmov instruction is a real instruction, which is why step (b) comprises adding at least one dummy cmov instruction to the third code.

For this purpose, as explained above, it is possible to add a plurality of dummy cmov instructions for each real cmov instruction, in particular by duplicating the real cmov instruction as many times as an object can take values.

Finally, the method for obfuscating may comprise a step (c) of transmitting the third code to the equipment 10a for storage on storage means 12a of an equipment 10a with a view to the execution by data processing means 11a of the equipment 10a for the implementation of said cryptographic algorithm, i.e. the method according to the first aspect.

### Computer Program Product

According to a third and fourth aspects, the invention relates to a computer program product comprising code instructions for execution (in particular on data processing means 11a, 11b of the equipment 10a and/or of the server 10b) of a method according to the first aspect or the second aspect of the invention of implementing or obfuscating a cryptographic algorithm with a given secret key, as well as storage means readable by computer equipment (a memory 12a, 12b of the equipment 10a and/or the server 10b) where this computer program product is found.

1. A method for implementing a cryptographic algorithm having a given secret key comprising the execution by data processing means (11a) of an equipment (10a) of a code implementing said cryptographic algorithm stored on data storage means (12a) of the equipment (10a), the method being characterized in that at least one so-called obfuscated part of said code parameterized with said secret key uses only one so-called cmov instruction, which is a conditional move instruction in a first operand of the instruction of a second operand of the instruction, at least one occurrence of said cmov instruction in said obfuscated part of the code being dummy.

2. The method according to claim 1, wherein said conditional move cmov instruction in a first operand of the instruction of a second operand of the instruction implements:
either, if the condition is verified, the actual move in the first operand of the second operand;
or, if the condition is not verified, a simulation of a move in the first operand of the second operand;
said dummy occurrence of the cmov instruction being intended to implement said move simulation in the first operand of the second operand during the normal execution of said code.

3. The method according to claim 2, wherein said move simulation in the first operand of the second operand comprises either the actual move in the first operand of the first operand or the actual move of the second operand elsewhere than in the first operand.

4. The method according to claim 1, wherein each conditional move cmov instruction in a first operand of the instruction of a second operand of the instruction is expressed from an encapsulated so-called mov unconditional move instruction in the first operand of the second operand.

5. The method according to claim 1, wherein the data processing means (11a) implement a secure execution environment, wherein said code implementing said cryptographic algorithm is executed, such as the Secure Guard Extension environment.

6. The method according to claim 1, wherein said obfuscated code part comprises a plurality of dummy occurrences of cmov instructions for each real occurrence of a cmov instruction.

7. The method according to claim 6, wherein for a set of an actual occurrence and the corresponding M−1 dummy occurrences of cmov instructions, corresponding to all the M possible values oᵢ of an object denoted o, including an expected value r, it results that:
for the i-th occurrence of the set, the displacement condition is “o is equal to oᵢ”;
the actual occurrence is the j-th such that oⱼ=r;
all other occurrences in the set are dummy occurrences.

8. The method according to claim 1, wherein said code is in an assembly language of the data processing means (11a).

9. The method according to claim 8, wherein said assembly language is the x86 assembler.

10. The method according to claim 1, wherein said cryptographic algorithm is a symmetrical encryption algorithm, said obfuscated part of the code implementing at least one round of said symmetrical encryption algorithm.

11. A method for obfuscating a cryptographic algorithm having a secret key represented by a first computer code comprising the implementation by data processing means (11b) of a server (10b) of the following steps:
(a) rewriting the first code into a second code wherein at least one so-called obfuscated part of said code using said secret key uses only one so-called mov instruction, which is an instruction for an unconditional move in a first operand of the instruction of a second operand of the instruction;
(b) generating a third code corresponding to the second code wherein each mov instruction of the obfuscated part is replaced by a so-called cmov instruction, which is an instruction for a conditional move in a first operand of the instruction of a second operand of the instruction, at least one dummy cmov instruction being added.

12. The method according to claim 11 comprising a step (c) of transmitting the third code to the equipment (10a) for storage on storage means (12a) of an equipment (10a) with a view to the execution by data processing means (11a) of the equipment (10a) for the implementation of said cryptographic algorithm.

13. A computer program product comprising code instructions for the execution of a method according to claim 1 for implementing a cryptographic algorithm having a given secret key, when said program is executed by a computer.
